(19) United States
(12) Patent Application Publication
(10) Pub. No.: US 2020/0270083 A1
(43) Pub. Date: Aug. 27, 2020

(54) SHEET CONVEYING APPARATUS

(71) Applicant: CANON KABUSHIKI KAISHA, Tokyo (JP)

(72) Inventors: Kazuya Fukuda, Kashiwa-shi (JP); Shigemi Kumagai, Kashiwa-shi (JP)

(21) Appl. No.: 16/778,667

(22) Filed: Jan. 31, 2020

(30) Foreign Application Priority Data
Feb. 26, 2019 (JP) 2019-033292

(51) Int. Cl. B65H 7/18; B65H 3/06

(52) U.S. Cl. CPC B65H 7/18; G03G 15/70; B65H 3/0669; B65H 3/0653

(57) ABSTRACT

A sheet conveying apparatus includes a stacking unit, a feeding unit, a conveying path, a first conveying roller, a second conveying roller, a controller configured to execute first driving for executing a driving of the first conveying roller and a driving of the second conveying roller, a discriminator configured to determine a position of the sheet based on a value of a parameter corresponding to a load torque applied to a motor for driving a conveying roller driven during the first driving, and a storage unit configured to store information regarding the position.

### BACKGROUND OF THE INVENTION

### Field of the Invention

The present disclosure relates to control of a motor in a sheet conveying apparatus.

### Description of the Related Art

In recent years, an image forming apparatus having the following configuration has been known. The image forming apparatus checks whether a paper sheet remains in a conveying path after a paper jam has occurred during the conveyance of the sheet and the paper jam is cleared. The check is performed based on a detection result of a sheet sensor to detect the presence of the sheet (United States Patent Application Publication No. 2016/0154364).

In the configuration of the United States Patent Application Publication No. 2016/0154364, however, the sheet sensor to detect the sheet needs to be provided in the conveying path. This makes the image forming apparatus large. Further, the provision of the sensor increases a cost.

### SUMMARY OF THE INVENTION

The present disclosure is directed to detecting a sheet with high accuracy using a less expensive configuration.

According to an aspect of the present disclosure, a sheet conveying apparatus that conveys a sheet includes a stacking unit in which the sheet is stacked, a feeding unit configured to feed the sheet stacked in the stacking unit, a conveying path in which the sheet is conveyed, a first conveying roller provided downstream of the feeding unit in a conveying direction in which the sheet is conveyed, the first conveying roller configured to convey the sheet fed by the feeding unit, a second conveying roller provided downstream of the feeding unit in a conveying direction, the second conveying roller configured to be fed by the feeding unit, a controller configured to, after an on timing when a power supply of the sheet conveying apparatus switches from an off state to an on state, and before a feeding timing when the feeding unit starts feeding the sheet first after the on timing, execute first driving for executing a driving of the first conveying roller and a driving of the second conveying roller, a discriminator configured to determine a position of the sheet in the conveying path based on a value of a parameter corresponding to a load torque applied to a motor for driving a conveying roller driven during the first driving, and a storage unit configured to store information regarding the position determined by the discriminator, wherein after the first driving is completed, the controller executes second driving for driving a conveying roller corresponding to the position, and wherein the discriminator determines the position of the sheet in the conveying path based on the value of the parameter corresponding to the load torque applied to a motor for driving a conveying roller driven during the second driving.

Further features of the present disclosure will become apparent from the following description of exemplary embodiments with reference to the attached drawings.

### BRIEF DESCRIPTION OF THE DRAWINGS

FIG. 1 is a cross-sectional view illustrating an image forming apparatus according to a first exemplary embodiment.

FIG. 2 is a block diagram illustrating a control configuration of the image forming apparatus according to the first exemplary embodiment.

FIG. 3 is a diagram illustrating a relationship between a two-phase motor having an A-phase and a B-phase, and a rotating coordinate system represented by a d-axis and a q-axis.

FIG. 4 is a block diagram illustrating a configuration of a motor control device.

FIG. 5 is a diagram illustrating a configuration in which conveying rollers are driven, according to the first exemplary embodiment.

FIG. 6 is a diagram illustrating an example of a deviation in a case where a sheet remains in a conveying path in a state where the sheet is nipped by conveying rollers and not nipped by other conveying rollers.

FIG. 7 is a diagram illustrating an example of the deviation in a case where a sheet remains in the conveying path in a state where the sheet is nipped by both the conveying rollers and the other conveying rollers.

FIG. 8 is a flowchart illustrating a method for detecting a sheet remaining in the conveying path according to the first exemplary embodiment.

FIGS. 9A and 9B illustrate a method for detecting a remaining sheet according to a second exemplary embodiment.

FIG. 10 consisting of FIGS. 10A and 10B is a flowchart illustrating the method for detecting a sheet remaining in the conveying path according to the second exemplary embodiment.

FIG. 11 is a block diagram illustrating a configuration of a motor control device that performs velocity feedback control.

### DESCRIPTION OF THE EMBODIMENTS

Suitable exemplary embodiments of the present disclosure will be described below, with reference to drawings. However, the shapes and the relative arrangement of components described in these exemplary embodiments should be appropriately changed depending on the configuration of an apparatus to which the present disclosure is applied and various conditions, and a scope of the present disclosure is not limited to the following exemplary embodiments. In the following description, a case is described where motor control devices are provided in an image forming apparatus. The motor control devices, however, are provided not only in an image forming apparatus. For example, the motor control devices are also used in a sheet conveying apparatus that conveys a sheet such as a recording medium or a document.

### [Image Forming Apparatus]

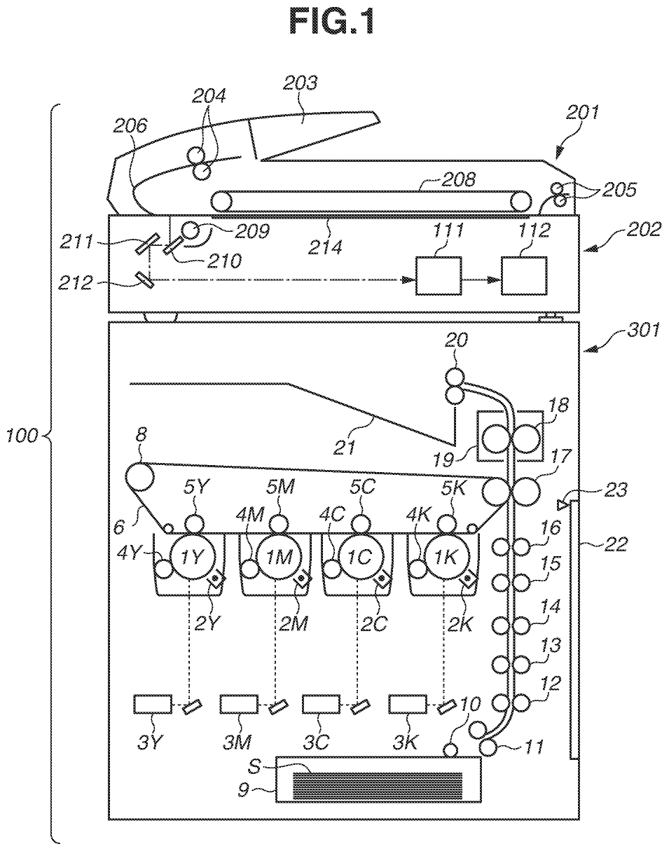

FIG. 1 is a cross-sectional view illustrating the configuration of a color electrophotographic copying machine (hereinafter referred to as “image forming apparatus”) 100 that includes a sheet conveying apparatus used in a first exemplary embodiment. The image forming apparatus 100 is not limited to a copying machine, and may be, for example, a facsimile apparatus, a printing machine, or a printer. A recording method is not limited to an electrophotographic method, and may be, for example, an inkjet method. Further, the format of the image forming apparatus 100 may be either of monochrome and color formats.

The configuration and the function of the image forming apparatus 100 are described below with reference to FIG. 1. As illustrated in FIG. 1, the image forming apparatus 100 includes a document feeding apparatus 201, a reading apparatus 202, and an image printing apparatus 301.

Documents stacked in a document stacking unit 203 of the document feeding apparatus 201 are fed one by one by sheet feeding rollers 204, and the fed document is conveyed along a conveyance guide 206 onto a document glass platen 214 of the reading apparatus 202. The document is conveyed at a constant velocity by a conveying belt 208 and discharged to a sheet discharge tray (not illustrated) by sheet discharge rollers 205. Reflected light from an image on the document illuminated by an illumination 209 at a reading position of the reading apparatus 202 is guided to an image reading unit 111 by an optical system including reflecting mirrors 210, 211, and 212. The reflected light is then converted into an image signal with respect to each color (e.g., yellow, magenta, cyan, and black) by the image reading unit 111. The image reading unit 111 includes a lens, a charge-coupled device (CCD), which is a photoelectric conversion element, and a driving circuit for the CCD. The image signal output from the image reading unit 111 is subjected to various correction processes by an image processing unit 112 that includes a hardware device such as an application-specific integrated circuit (ASIC). The resulting image signal is then output to the image printing apparatus 301. As described above, a document is read. In other words, the document feeding apparatus 201 and the reading apparatus 202 function as a document reading apparatus.

Document reading modes include a first reading mode and a second reading mode. The first reading mode is a mode where the illumination system and the optical system fixed at predetermined positions read an image on a conveyed document. The second reading mode is a mode where the illumination system and the optical system that are moving read an image on a document placed on the document glass platen 214 of the reading apparatus 202. Normally, an image on a sheet-like document is read in the first reading mode, and an image on a bound document such as a book or a booklet is read in the second reading mode.

A sheet holding tray 9 that holds a recording medium is provided within the image printing apparatus 301. On the recording medium, an image is to be formed by the image forming apparatus 100. Examples of the recording medium include a sheet, a resin sheet, cloth, an overhead projector (OHP) sheet, and a label.

The recording medium held in the sheet holding tray 9 is sent out by a pickup roller 10 and conveyed to registration rollers 16 by conveying rollers 11 to 15. The pickup roller 10 is included in a feeding unit.

The image signal output from the reading apparatus 202 is input with respect to color components to optical scanning devices 3Y, 3M, 3C, and 3K, each including a semiconductor laser and a polygon mirror. Specifically, the image signal regarding yellow output from the reading apparatus 202 is input to the optical scanning device 3Y. The image signal regarding magenta output from the reading apparatus 202 is input to the optical scanning device 3M. The image signal regarding cyan output from the reading apparatus 202 is input to the optical scanning device 3C. The image signal regarding black output from the reading apparatus 202 is input to the optical scanning device 3K. Although the following description is given of a configuration in which a yellow image is formed, similar configurations are also provided for magenta, cyan, and black images.

The outer peripheral surface of a photosensitive drum 1Y is charged by a charging device 2Y. After the outer peripheral surface of the photosensitive drum 1Y is charged, laser light according to the image signal input from the reading apparatus 202 to the optical scanning device 3Y is emitted from the optical scanning device 3Y to the outer peripheral surface of the photosensitive drum 1Y via an optical system such as the polygon mirror. Accordingly, an electrostatic latent image is formed on the outer peripheral surface of the photosensitive drum 1Y.

The electrostatic latent image is then developed with toner in a developing device 4Y, thereby forming a toner image on the outer peripheral surface of the photosensitive drum 1Y. The toner image formed on the photosensitive drum 1Y is transferred onto a transfer belt 6 by a transfer roller 5Y provided at a position opposed to the photosensitive drum 1Y.

The yellow, magenta, cyan, and black toner images transferred onto the transfer belt 6 are transferred onto the recording medium by a transfer roller pair 17. According to this transfer timing, the registration rollers 16 send the recording medium into the transfer roller pair 17.

As described above, the recording medium onto which the toner images have been transferred is sent into a fixing device 19 and is heated and pressurized by the fixing device 19, thereby fixing the toner images to the recording medium. In this manner, an image is formed on a recording medium by the image forming apparatus 100. The recording medium on which the image is formed is discharged to a sheet discharge tray 21 by sheet discharge rollers 20.

In the image forming apparatus 100 according to the present exemplary embodiment, a door 22 is provided that enables a user to remove a sheet remaining in a conveying path. The user can remove a sheet remaining in the conveying path by opening the door 22. A door sensor 23 is provided that detects the opening and closing of the door 22, in the image forming apparatus 100 according to the present exemplary embodiment.

The above is the description of the configuration and the function of the image forming apparatus 100.

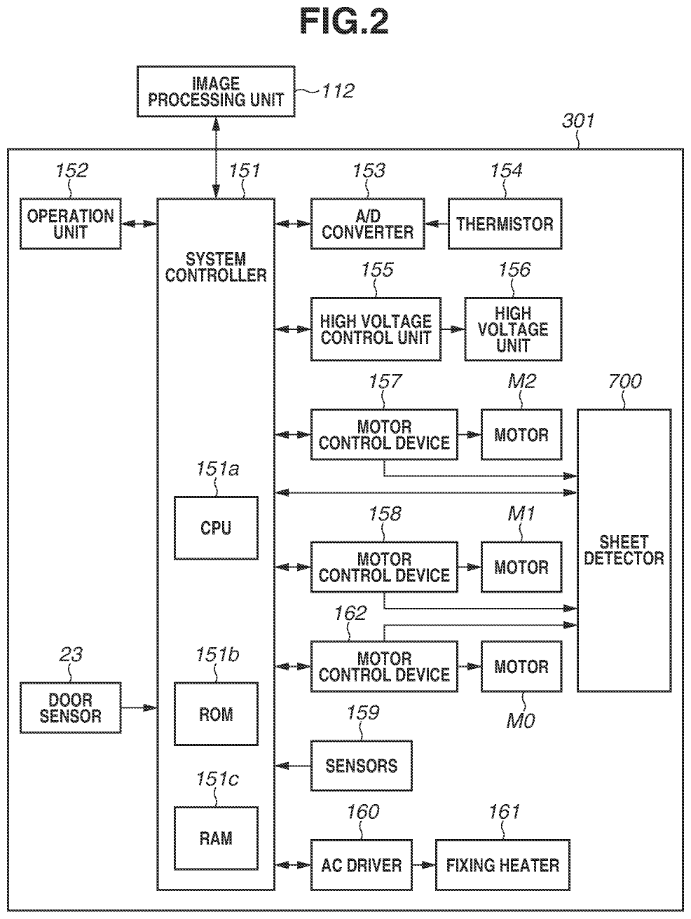

FIG. 2 is a block diagram illustrating an example of the control configuration of the image forming apparatus 100. As illustrated in FIG. 2, a system controller 151 includes a central processing unit (CPU) 151a, a read-only memory (ROM) 151b, and a random-access memory (RAM) 151c. The system controller 151 is connected to the image processing unit 112, an operation unit 152, an analog-to-digital (A/D) converter 153, a high voltage control unit 155, motor control devices 157, 158, and 162, sensors 159, an alternating current (AC) driver 160, a sheet detector 700, and the door sensor 23. The system controller 151 can transmit and receive data and a command to and from the units connected to the system controller 151.

The CPU 151a reads and executes various programs stored in the ROM 151b, and thereby executes various sequences related to an image forming sequence determined in advance.

The RAM 151c is a storage device. The RAM 151c stores various types of data, such as a setting value for the high voltage control unit 155, an instruction value for the motor control device 157, and information received from the operation unit 152.

The system controller 151 transmits setting value data, required for image processing by the image processing unit 112, of the various devices provided within the image forming apparatus 100 to the image processing unit 112. The system controller 151 further receives signals from the sensors 159, and sets a setting value of the high voltage control unit 155 based on the received signals.

The high voltage control unit 155 supplies a required voltage to a high voltage unit 156 (e.g., the charging devices 2Y, 2M, 2C, and 2K and the developing devices 4Y, 4M, 4C, and 4K) based on the setting value set by the system controller 151.

The motor control device 157 controls a motor (e.g., stepper motor) M2 for driving the conveying rollers 13 based on an instruction output from the CPU 151a. The motor control device 158 controls a motor (e.g., stepper motor) M1 for driving the conveying rollers 12 based on an instruction output from the CPU 151a. The motor control device 162 controls a motor (e.g., stepper motor) M0 for driving the conveying rollers 11 based on an instruction output from the CPU 151a. Although only the motors M0, M1, and M2 are illustrated as motors of the image forming apparatus 100 in FIG. 2, actually, four or more motors are provided in the image forming apparatus 100. Alternatively, a configuration may be employed in which a single motor control device controls one or more of motors. Although only three motor control devices are provided in FIG. 2, actually, four or more motor control devices are provided in the image forming apparatus 100.

The A/D converter 153 receives a detected signal detected by a thermistor 154 that detects the temperature of a fixing heater 161. The A/D converter 153 then converts the detected signal from an analog signal to a digital signal and transmits the digital signal to the system controller 151. The system controller 151 controls the AC driver 160 based on the digital signal received from the A/D converter 153. The AC driver 160 controls the fixing heater 161 so that the temperature of the fixing heater 161 becomes a temperature required to perform a fixing process. The fixing heater 161, which is included in the fixing device 19, is used for the fixing process.

The system controller 151 controls the operation unit 152 to display, on a display unit provided in the operation unit 152, an operation screen for the user to set, for example, the type of a recording medium to be used (hereinafter referred to as the “paper type”). The system controller 151 receives information set by the user from the operation unit 152, and controls the operation sequence of the image forming apparatus 100 based on the information set by the user. The system controller 151 transmits information indicating the state of the image forming apparatus 100 to the operation unit 152. The information indicating the state of the image forming apparatus 100 is, for example, information regarding the number of images to be formed, the progress state of an image forming operation, a jam or multi-feed of a sheet in the document feeding apparatus 201 and the image printing apparatus 301, and a sheet remaining in the conveying path. The operation unit 152 displays on the display unit the information received from the system controller 151.

As described above, the system controller 151 controls the operation sequence of the image forming apparatus 100. The sheet detector 700 will be described below.

### [Motor Control Device]

Next, the motor control devices according to the present exemplary embodiment are described. The motor control devices according to the present exemplary embodiment control motors using vector control. In the following description, control described below is performed based on, for example, a rotational phase θ, an instruction phase θ_ref, and the phase of a current as electrical angles. Alternatively, control described below may be performed based on, for example, mechanical angles converted from the electrical angles.

### <Vector Control>

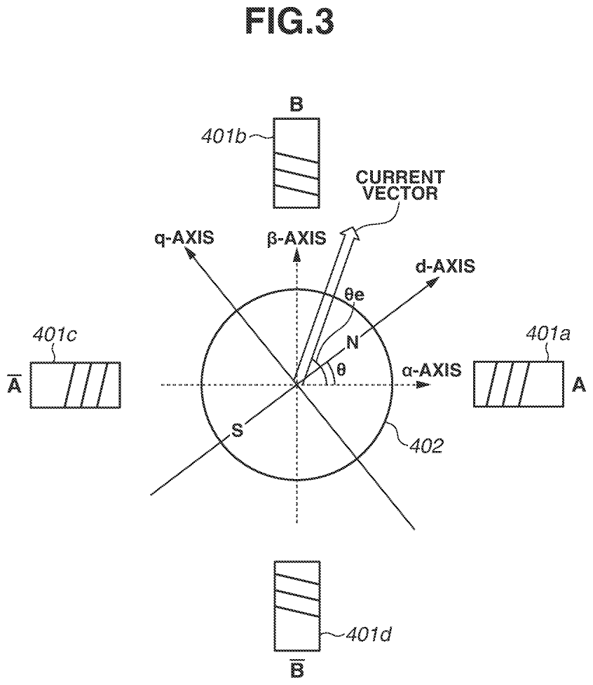

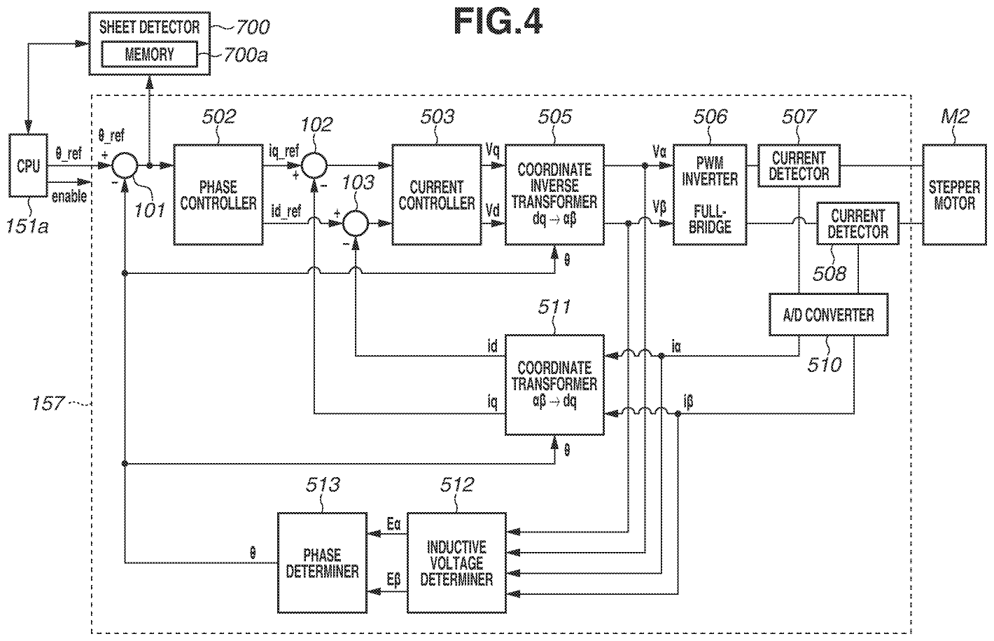

First, a description is given, with reference to FIGS. 3 and 4, of a method in which the motor control device 157 performs vector control, according to the present exemplary embodiment. The configurations of the motor control devices 158 and 162 are similar to that of the motor control device 157, and therefore are not described here. In a motor in the following description, a sensor such as a rotary encoder for detecting the rotational phase of a rotor of the motor is not provided. Alternatively, a sensor such as a rotary encoder may be provided.

3 is a diagram illustrating the relationship between the stepper motor (hereinafter referred to as “motor”) M2 having two phases such as an A-phase (a first phase) and a B-phase (a second phase), and a rotating coordinate system represented by a d-axis and a q-axis. In FIG. 3, an a-axis, which is an axis corresponding to coils in the A-phase, and a β-axis, which is an axis corresponding to coils in the B-phase, are defined in a stationary coordinate system. In FIG. 3, the d-axis is defined along the direction of magnetic flux created by the magnetic poles of a permanent magnet used in a rotor 402. The q-axis is defined along a direction rotated 90 degrees counterclockwise from the d-axis (a direction orthogonal to the d-axis). The angle between the α-axis and the d-axis is defined as θ, and the rotational phase of the rotor 402 is represented by the angle θ. In the vector control, a rotating coordinate system based on a rotational phase θ of the rotor 402 is used. Specifically, a q-axis component (a torque current component) and a d-axis component (an excitation current component), which are current components in the rotating coordinate system of a current vector corresponding to a driving current flowing through each coil, are used in the vector control. The q-axis component (the torque current component) generates a torque in the rotor 402, and the d-axis component (the excitation current component) influences the strength of magnetic flux passing through the coil.

The vector control is a control method for controlling a motor by performing phase feedback control for controlling the value of a torque current component and the value of an excitation current component so that the deviation between an instruction phase indicating a target phase of a rotor and an actual rotational phase of the rotor becomes small. There is also a method for controlling a motor by performing velocity feedback control for controlling the value of a torque current component and the value of an excitation current component so that the deviation between an instruction velocity indicating a target velocity of a rotor and an actual rotational velocity of the rotor becomes small.

FIG. 4 is a block diagram illustrating an example of the configuration of the motor control device 157 that controls the motor M2. The motor control device 157 includes at least one ASIC and executes functions described below.

As illustrated in FIG. 4, the motor control device 157 includes a phase controller 502, a current controller 503, a coordinate inverse transformer 505, a coordinate transformer 511, and a pulse-width modulation (PWM) inverter 506 that supplies driving currents to the coils of the motor M2. These circuits are configured to perform the vector control. The coordinate transformer 511 performs coordinate transformation on current vectors corresponding to driving currents flowing through the coils in the A-phase and the B-phase of the motor M2, from the stationary coordinate system represented by the α-axis and the β-axis to the rotating coordinate system represented by the q-axis and the d-axis. Consequently, the driving currents flowing through the coils are represented by the current value of the q-axis component (a q-axis current) and the current value of the d-axis component (a d-axis current), which are current values in the rotating coordinate system. The q-axis current corresponds to a torque current that generates a torque in the rotor 402 of the motor M2. The d-axis current corresponds to an excitation current that influences the strength of magnetic flux passing through each coil of the motor M2. The motor control device 157 can independently control the q-axis current and the d-axis current. Accordingly, the motor control device 157 controls the q-axis current based on a load torque applied to the rotor 402 and thereby can efficiently generate a torque required for the rotation of the rotor 402. In other words, the magnitude of the current vector illustrated in FIG. 3 changes according to the load torque applied to the rotor 402, in the vector control.

The motor control device 157 determines the rotational phase θ of the rotor 402 of the motor M2 using a method described below, and performs the vector control based on the determination result. The CPU 151a generates an instruction phase θ_ref that indicates a target phase of the rotor 402 of the motor M2, and outputs the instruction phase θ_ref to the motor control device 157. The instruction phase θ_ref is set based on a target velocity of the rotor 402 of the motor M2 corresponding to a target velocity of the peripheral velocity of the conveying rollers 13.

A subtractor 101 calculates and outputs a deviation Δθ between the rotational phase θ of the rotor 402 of the motor M2, which is output from a phase determiner 513, and the instruction phase θ_ref.

The phase controller 502 acquires the deviation Δθ at intervals of T (e.g., 200 μs). The phase controller 502 generates and outputs a q-axis current instruction value iq_ref and a d-axis current instruction value id_ref, based on proportional control (P), integral control (I), and derivative control (D), so that the deviation Δθ acquired from the subtractor 101 becomes small. Specifically, the phase controller 502 generates and outputs the q-axis current instruction value iq_ref and the d-axis current instruction value id_ref, based on the P-control, the I-control, and the D-control, so that the deviation Δθ output from the subtractor 101 becomes 0. The P-control is a control method for controlling the value of a target to be controlled, based on a value proportional to the deviation between an instruction value and an estimated value. The I-control is a control method for controlling the value of the target to be controlled, based on a value proportional to the time integral of the deviation between the instruction value and the estimated value. The D-control is a control method for controlling the value of the target to be controlled, based on a value proportional to a change over time in the deviation between the instruction value and the estimated value. The phase controller 502 according to the present exemplary embodiment generates the q-axis current instruction value iq_ref and the d-axis current instruction value id_ref based on proportional-integral-derivative (PID) control. The present disclosure, however, is not limited to the PID control. For example, the phase controller 502 may generate the q-axis current instruction value q_ref and the d-axis current instruction value id_ref based on proportional-integral (PI) control. In a case where a permanent magnet is used in the rotor 402, normally, the d-axis current instruction value id_ref, which influences the strength of magnetic flux passing through each coil, is set to 0. The present disclosure, however, is not limited to this setting.

Driving currents flowing through the coils in the A-phase and the B-phase of the motor M2 are detected by current detectors 507 and 508, and then converted from analog values to digital values by an A/D converter 510. The cycle in which the current detectors 507 and 508 detect the currents is, for example, a cycle (e.g., 25 μs) that is less than or equal to the cycle T, in which the phase controller 502 acquires the deviation Δθ.

The current values of the driving currents converted from the analog values to the digital values by the AD converter 510 are represented as current values iα and iβ in the stationary coordinate system by the following formulas, using a phase θe of the current vector illustrated in FIG. 3. The phase θe of the current vector is defined as an angle between the α-axis and the current vector. I represents the magnitude of the current vector.

αs=I*cos θe (1)

iβ=I*sin θe (2)

The current values iα and iβ are input to the coordinate transformer 511 and an inductive voltage determiner 512.

The coordinate transformer 511 transforms the current values iα and iβ in the stationary coordinate system into a current value iq of the q-axis current and a current value id of the d-axis current in the rotating coordinate system by the following formulas.

id=cos θ*iα+sin θ*iβ (3)

iq=−sin θ*iα+cos θ*iβ (4)

The coordinate transformer 511 outputs the transformed current value iq to a subtractor 102. The coordinate transformer 511 outputs the transformed current value id to a subtractor 103.

The subtractor 102 calculates the deviation between the q-axis current instruction value iq_ref and the current value iq, and outputs the calculated deviation to the current controller 503.

The subtractor 103 calculates the deviation between the d-axis current instruction value id_ref and the current value id, and outputs the calculated deviation to the current controller 503.

The current controller 503 generates, based on the PID control, driving voltages Vq and Vd so that each of the deviations input to the current controller 503 becomes small. Specifically, the current controller 503 generates the driving voltages Vq and Vd so that each of the deviations input to the current controller 503 becomes zero. The current controller 503 then outputs the driving voltages Vq. and Vd to the coordinate inverse transformer 505. In other words, the current controller 503 functions as a generation unit. The current controller 503 according to the present exemplary embodiment generates the driving voltages Vq and Vd based on the PID control. The present disclosure, however, is not limited to this control. For example, the current controller 503 may generate the driving voltages Vq and Vd based on the PI control.

The coordinate inverse transformer 505 inversely transforms the driving voltages Vq and Vd in the rotating coordinate system, which are output from the current controller 503, into driving voltages Vα and Vβ in the stationary coordinate system by the following formulas.

Vα=cos θ*Vd−sin θ*Vq (5)

vβ=sin θ*Vd+cos θ*Vq (6)

The coordinate inverse transformer 505 outputs the inversely transformed driving voltages Vα and Vβ to the inductive voltage determiner 512 and the PWM inverter 506.

The PWM inverter 506 includes a full-bridge circuit (an H-bridge circuit). The full-bridge circuit is driven by PWM signals based on the driving voltages Vα and vβ input from the coordinate inverse transformer 505. Accordingly, the PWM inverter 506 generates driving currents iα and iβ according to the driving voltages Vα and vβ and supplies the driving currents iα and iβ to the coils in the respective phases of the motor M2, thereby driving the motor M2. In other words, the PWM inverter 506 functions as a supply unit for supplying currents to the coils in the respective phases of the motor M2. In the present exemplary embodiment, the PWM inverter 506 includes a full-bridge circuit. Alternatively, the PWM inverter 506 may be, for example, a half-bridge circuit.

Next, a determination method for the rotational phase θ will be described. The rotational phase θ of the rotor 402 is determined using the values of inductive voltages Ea and EP induced in the coils in the A-phase and the B-phase of the motor M2 by the rotation of the rotor 402. The value of each inductive voltage is determined (calculated) by the inductive voltage determiner 512. Specifically, the inductive voltages Ea and EP are determined using the following formulas, based on the current values iα and iβ input from the A/D converter 510 to the inductive voltage determiner 512 and the driving voltages Vα and Vβ input from the coordinate inverse transformer 505 to the inductive voltage determiner 512.

Eα=Vα−R*iα−L*diα/dt (7)

Eβ=Vβ−R*iβ−L*diβ/dt (8)

In the formulas (7) and (8), R represents coil resistance, and L represents coil inductance. The values of the coil resistance R and the coil inductance L are values specific to the motor M2 in use and are stored in advance in the ROM 151b or a memory (not illustrated) provided in the motor control device 157.

The inductive voltages Eα and Eβ determined by the inductive voltage determiner 512 are output to the phase determiner 513.

Based on the ratio between the inductive voltages Ea and EP output from the inductive voltage determiner 512, the phase determiner 513 determines the rotational phase θ of the rotor 402 of the motor M2 by the following formula.

θ=tan \hat{ }−1(−Eβ/Eα) (9)

In the present exemplary embodiment, the phase determiner 513 determines the rotational phase θ by performing calculation based on formula (9). The present disclosure, however, is not limited to this. For example, the phase determiner 513 may determine the rotational phase θ by referencing a table stored in the ROM 151b and illustrating the relationships between the inductive voltages Eα and Eβ, and the rotational phase θ corresponding to the inductive voltages Eα and Eβ.

The rotational phase θ of the rotor 402 obtained as described above is input to the subtractor 101, the coordinate inverse transformer 505, the coordinate transformer 511, and the sheet detector 700.

The motor control device 157 repeatedly performs the above control.

As described above, the motor control device according to the present exemplary embodiment performs the vector control for controlling current values in the rotating coordinate system so that the deviation between the instruction phase θ_ref and the rotational phase θ becomes small. The vector control can prevent a motor from entering a step-out state and prevent an increase of the motor sound and power consumption due to an excess torque.

### [Method for Detecting Sheet Remaining in Conveying Path]

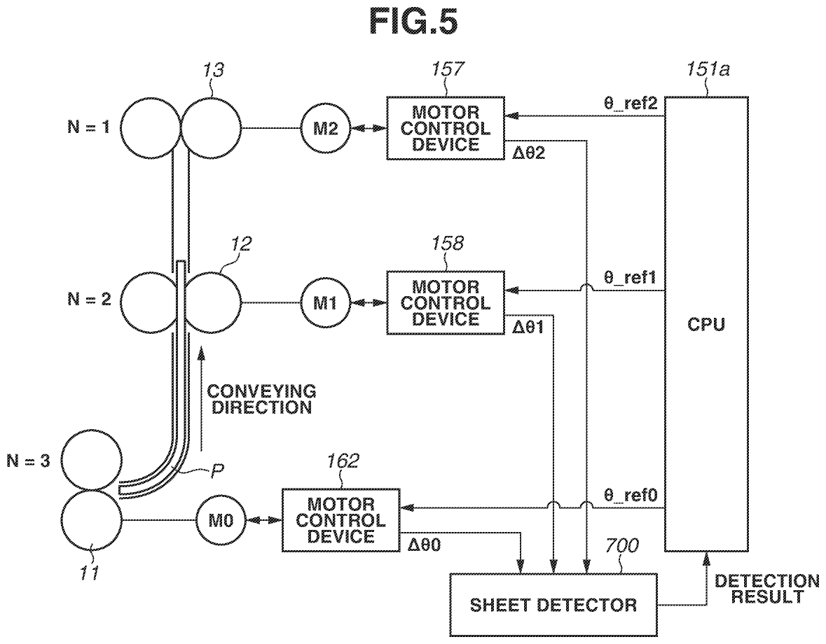

FIG. 5 is a diagram illustrating a configuration in which conveying rollers are driven, according to the present exemplary embodiment. FIG. 5 illustrates the state where a sheet remains nipped by the conveying rollers 12 in the conveying path.

As illustrated in FIG. 5, the conveying rollers 11 are driven by the motor M0, which is controlled by the motor control device 162. The conveying rollers 12 are driven by the motor M1, which is controlled by the motor control device 158. The conveying rollers 13 are driven by the motor M2, which is controlled by the motor control device 157. The motor control devices 157, 158, and 162 illustrated in FIG. 5 control the motors M2, M1, and M0 as control targets by the vector control.

A description is given below of a method for detecting a sheet remaining in the conveying path due to the fact that the operation of the image forming apparatus 100 stops (a method for detecting the presence of the sheet), according to the present exemplary embodiment.

In the following description, the motor control devices 157, 158, and 162 perform phase feedback control based on the instruction phase ref output from the CPU 151a. The instruction phase θ ref is generated by the CPU 151a based on a target velocity of each of the motors M2, M1, and M0. Actually, the CPU 151a outputs a pulse signal to each of the motor control devices 157, 158, and 162. The number of pulses corresponds to an instruction phase, and the frequency of pulses corresponds to a target velocity. The target velocity is determined based on a target value of the peripheral velocity of each of the conveying rollers.

As illustrated in FIG. 5, an integer N representing the order from the conveying rollers 13 to the conveying rollers 11 is set, in the present exemplary embodiment. For example, N=1 indicates the conveying rollers 13. N=3 indicates the conveying rollers 11.

In the present exemplary embodiment, rollers corresponding to the numbers N and N+1 are driven when the operation of the image forming apparatus 100 is resumed (e.g., the power supply of the image forming apparatus 100 is turned on). The sheet detector 700 then detects the presence of a remaining sheet based on the deviation Δθ of a motor for driving the rollers corresponding to the number N. In other words, the presence of a sheet is not determined based on a signal of a sensor such as a photosensor but is determined based on a signal output from a motor control device. The sheet detector 700 outputs a signal indicating the presence of a sheet as a detection result to the CPU 151a, for example, every time the sheet detector 700 acquires the deviation Δθ.

In the present exemplary embodiment, the rollers corresponding to the Ser. No. N are driven at a peripheral velocity V1, and the rollers corresponding to the number N+1 are driven at a peripheral velocity V2. The peripheral velocity V1 is a peripheral velocity greater than the peripheral velocity V2 by ΔV. In other words, in the present exemplary embodiment, the rollers corresponding to the number N (i.e., the downstream rollers) and the rollers corresponding to the number N+1 (the upstream rollers) are driven in the state where the peripheral velocity of the rollers corresponding to the number N is faster by ΔV than the peripheral velocity of the rollers corresponding to the number N+1. The peripheral velocities of the rollers when the presence of a remaining sheet is detected are set to, for example, peripheral velocities slower than the peripheral velocities of the conveying rollers when a sheet is conveyed in the execution of an image forming operation. The peripheral velocities of the rollers when the presence of a remaining sheet is detected are set to, for example, peripheral velocities half the peripheral velocities of the rollers when a sheet is conveyed in the execution of an image forming operation.

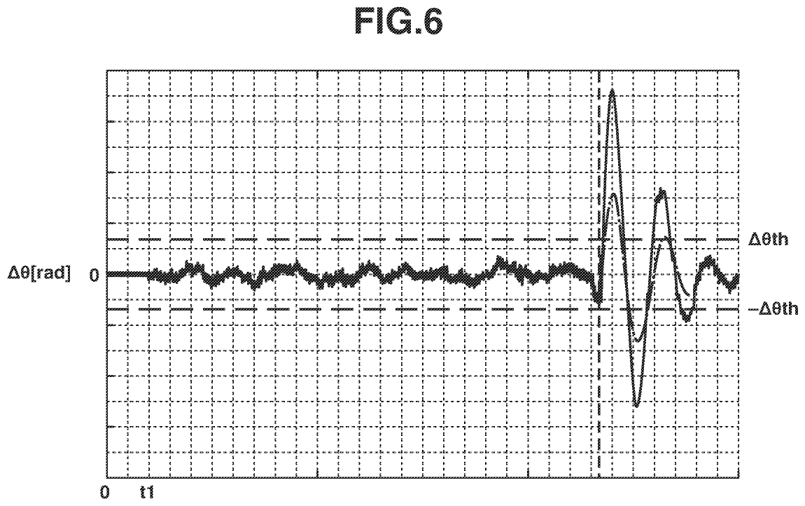

FIG. 6 is a diagram illustrating an example of a deviation Δθ2 of the motor M2 for driving the conveying rollers 13 in a case where the conveying rollers 12 and 13 are driven (i.e., N=1) when the power supply of the image forming apparatus 100 is turned on. A time t1 is the time when the driving of the conveying rollers 13 is started. In FIG. 6, the deviation Δθ having a positive value means that the rotational phase θ is behind the instruction phase θ_ref. The deviation Δθ having a negative value means that the rotational phase θ is ahead of the instruction phase θ_ref. However, the relationships between the polarity of the deviation Δθ, and the rotational phase θ and the instruction phase θ_ref are not limited to the relationships described above. For example, a configuration may be employed in which, in a case where the rotational phase θ is behind the instruction phase θ_ref, the deviation Δθ has a negative value, and in a case where the rotational phase θ is ahead of the instruction phase θ_ref, the deviation Δθ has a positive value.

If a sheet is conveyed by the conveying rollers 12 in the state where the sheet is nipped by the conveying rollers 12 and the sheet is not nipped by the conveying rollers 13, the front end of the sheet reaches a nip portion of the conveying rollers 13 that are being driven. In the state where the sheet is not nipped by the conveying rollers 13, a torque Tr required to drive the conveying rollers 13 is applied to the motor M2 for driving the conveying rollers 13.

When the sheet is conveyed by the conveying rollers 13, the load torque applied to the motor M2 for driving the conveying rollers 13 increases and becomes greater than the torque Tr. If the load torque applied to the motor M2 increases, the absolute value of the deviation Δθ fluctuates due to the fact that the rotational phase θ of the rotor 402 of the motor M2 is behind the instruction phase θ ref. Specifically, for example, the absolute value of the deviation Δθ increases as illustrated in FIG. 6.

A dashed-dotted line illustrated in FIG. 6 indicates the deviation Δθ2 occurring in a case where the conveying rollers 12 and 13 are driven at the same peripheral velocity. A solid line illustrated in FIG. 6 indicates the deviation Δθ2 occurring in a case where the conveying rollers 13 are driven at a peripheral velocity greater than that of the conveying rollers 12 in the state where a sheet is nipped by the conveying rollers 12 and 13.

The amount of increase in the load torque applied to the motor M2 when the sheet becomes conveyed by both the conveying rollers 12 and 13 is greater in a case where the conveying rollers 13 rotate at a peripheral velocity greater than that of the conveying rollers 12, than in a case where the conveying rollers 13 rotate at the same peripheral velocity as that of the conveying rollers 12. This is because in a case where the conveying rollers 13 rotate at a peripheral velocity greater than that of the conveying rollers 12, the conveying rollers 13 pull the sheet nipped by the conveying rollers 12 downstream. The greater the amount of increase in the load torque applied to the conveying rollers 13 is, the greater the amount of increase in the absolute value of the deviation Δθ is. Specifically, as illustrated in FIG. 6, the amount of fluctuation in the deviation Δθ indicated by the solid line is greater than the amount of fluctuation in the deviation Δθ indicated by the dashed-dotted line. The conveying rollers 13 are driven at a peripheral velocity greater than that of the conveying rollers 12, whereby it is possible to make the amount of fluctuation in the deviation Δθ greater. Thus, the remaining sheet can be detected with higher accuracy.

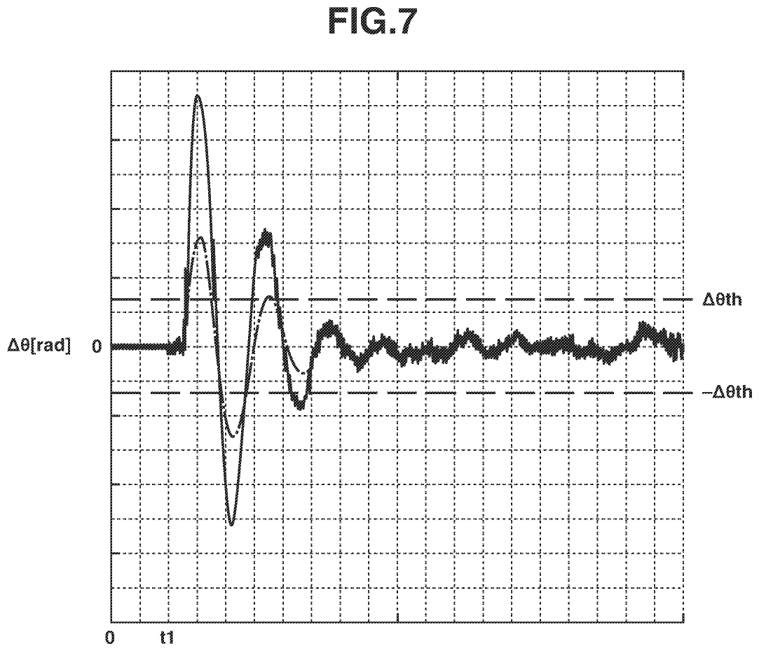

In a case where a sheet remains in the conveying path in the state where the sheet is nipped by both the conveying rollers 12 and 13 and the conveying rollers 12 and 13 are driven, the sheet is conveyed by both the conveying rollers 13 and 12. At this time, the conveying rollers 13 pull the sheet nipped by the conveying rollers 12 downstream, because the conveying rollers 13 are driven at a peripheral velocity greater than that of the conveying rollers 12. Accordingly, the load torque applied to the motor M2 becomes greater than the torque Tr. Thus, it is possible to make the amount of fluctuation in the deviation Δθ greater. Specifically, the deviation Δθ fluctuates, for example, as illustrated in FIG. 7. A dashed-dotted line indicates the deviation Δθ2 in a case where the conveying rollers 12 and 13 are driven at the same peripheral velocity. A solid line indicates the deviation Δθ2 in a case where the conveying rollers 13 are driven at a peripheral velocity greater than that of the conveying rollers 12. The conveying rollers 13 are driven at a peripheral velocity greater than that of the conveying rollers 12, whereby the remaining sheet can be detected with higher accuracy.

As described above, the present exemplary embodiment is applied not only to a case where a sheet remains in the conveying path in the state where the sheet is nipped by the conveying rollers 12 and the sheet is not nipped by the conveying rollers 13, but also to a case where a sheet remains in the conveying path in the state where the sheet is nipped by both the conveying rollers 12 and 13.

As illustrated in FIGS. 6 and 7, in the present exemplary embodiment, a threshold Δθth (e.g., a predetermined value) is set as a threshold for the deviation Δθ for detecting the presence of a sheet. If the absolute value of the acquired deviation Δθ2 is greater than or equal to the threshold Δθth, the sheet detector 700 outputs a signal indicating that the absolute value of the deviation Δθ2 is greater than or equal to the threshold Δθth. If the absolute value of the deviation Δθ2 is less than the threshold Δθth, the sheet detector 700 outputs a signal indicating that the absolute value of the deviation Δθ2 is less than the threshold Δθth.

The threshold Δθth is set to a value greater than the maximum value of the absolute value of the deviation Δθ2 assumed when the conveying rollers 13 are driven in the state where a sheet is not nipped by the conveying rollers 13. The maximum value of the absolute value of the deviation Δθ2 assumed when the conveying rollers 13 are driven in the state where a sheet is not nipped by the conveying rollers 13 is determined based on the result measured by experiment in advance.

The threshold Δθth is set to a value smaller than the maximum value of the absolute value of the deviation Δθ2 assumed when a sheet becomes conveyed (nipped) by the conveying rollers 13. The maximum value of the absolute value of the deviation Δθ2 assumed when a sheet becomes conveyed (nipped) by the conveying rollers 13 is determined based on the result measured by experiment in advance.

In other words, the absolute value of the deviation Δθ2 greater than or equal to the threshold Δθth means that a sheet is nipped by (that a sheet remains in) the nip portion of the conveying rollers 13.

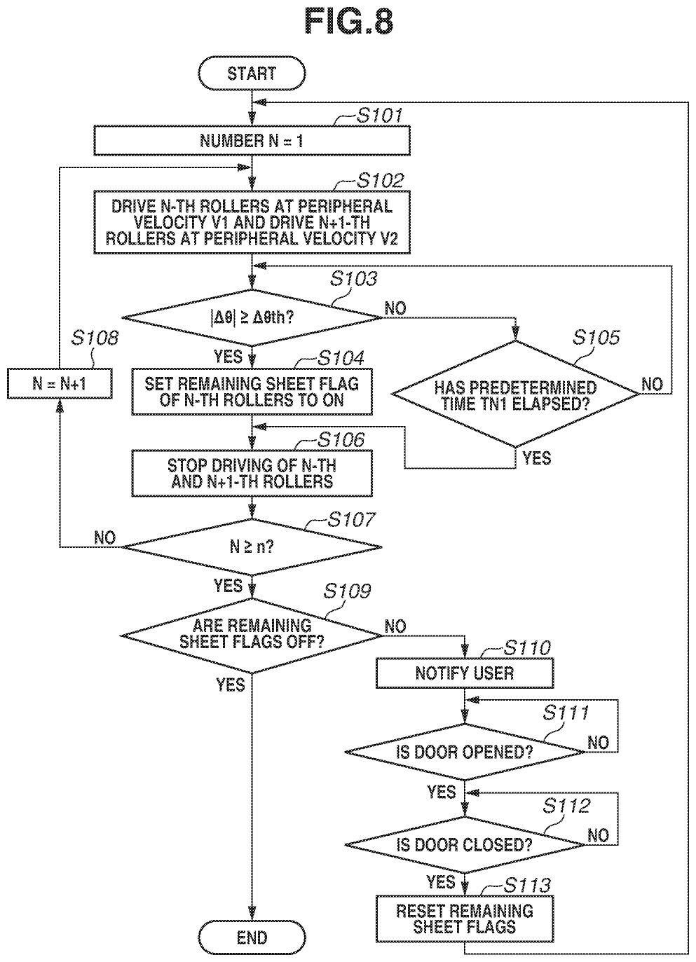

FIG. 8 is a flowchart illustrating the method for detecting a sheet remaining in the conveying path. A description is given below of the method for detecting a sheet remaining in the conveying path with reference to FIG. 8. The processing of the flowchart is executed by the CPU 151a. The processing of the flowchart is started when the power supply of the image forming apparatus 100 enters an on state, i.e., in the state where an image forming process has not yet started.

If the power supply of the image forming apparatus 100 enters an on state, then in step S101, the CPU 151a sets the number N to ‘1’.

In step S102, the CPU 151a outputs, to a motor control device that controls a motor for driving rollers corresponding to the number N, an instruction to drive the motor as the control target so that the rollers corresponding to the number N rotate at the peripheral velocity V1. The CPU 151a outputs, to a motor control device that controls a motor for driving rollers corresponding to the number N+1, an instruction to drive the motor as the control target so that the rollers corresponding to the number N+1 rotate at the peripheral velocity V2. Consequently, the rollers corresponding to the number N are driven at the peripheral velocity V1, and the rollers corresponding to the number N+1 are driven at the peripheral velocity V2.

In step S103, if the sheet detector 700 outputs a signal indicating that the absolute value of the deviation Δθ of the motor for driving the N-th rollers driven in step S102 is greater than or equal to the threshold Δθth (YES in step S103), the processing proceeds to step S104. In step S104, the CPU 151a sets a remaining sheet flag of the rollers corresponding to the number N to on. Specifically, the CPU 151a stores, for example, in the RAM 151c, information indicating that a sheets nipped by the rollers corresponding to the number N.

In step S103, if the absolute value of the deviation Δθ of the motor for driving the N-th rollers driven in step S102 is less than the threshold Δθth (NO in step S103), the processing proceeds to step S105.

In step S105, if a predetermined time TN1 has not elapsed since the motors have been driven in step S102 (NO in step S105), the processing returns to step S103.

In step S105, if the predetermined time TN1 has elapsed since the motors have been driven in step S102 (YES in step S105), the processing proceeds to step S105. In step S106, the CPU 151a outputs, to the motor control devices that control the motors for driving the respective pairs of rollers, instructions to stop the driving of the N-th and N+1-th rollers. Consequently, the driving of the N-th and N+1-th rollers is stopped.

The predetermined time TN1 is set to time required for the N+1-th conveying rollers rotating at the peripheral velocity V2 to convey a sheet by the distance from a nip portion of the N+1-th conveying rollers to a nip portion of the N-th conveying rollers in other words, the time TN1 is set according to the distance from the nip portion of the N+1-th conveying rollers to the nip portion of the N-th conveying rollers (i.e., according to the number N). As described above, in the present exemplary embodiment, the remaining sheet flag is set to on, if the absolute value of the deviation Δθ becomes greater than or equal to the threshold Δθth during the period from when the driving of the N-th conveying rollers is started to when the time TN1 has elapsed. Then the driving of the N-th and N+1-th conveying rollers is stopped, even if the time TN1 has not elapsed. The driving of the N-th and N+1-th conveying rollers is stopped, if the absolute value of the deviation Δθ has not become greater than or equal to the threshold Seth during the time period of TN1.

In step S107, if the number N is less than n (NO in step S107), the processing proceeds to step S108. In step S108, the CPU 151a sets N=N+1, and the processing returns to step S102. In the above description, n represents the number (e.g., three in the present exemplary embodiment) of rollers from the conveying rollers 13 to the furthest upstream conveying rollers as detection targets of presence of a sheet in the conveying direction.

In step S107, if the number N is greater than or equal to n (YES in step S107), the processing proceeds to step S109.

In step S109, if there are rollers of which a remaining sheet flag is on (NO in step S109), the processing proceeds to step S110. In step S110, the CPU 151a notifies the user that the sheet remains within the image forming apparatus 100, and also notifies the user of the place where the sheet remains, by displaying the notifications on the display unit of the operation unit 152.

In step S111, if the door sensor 23 detects that the door 22 is opened (YES in step S111), the processing proceeds to step S11.

In step S112, if the door sensor 23 detects that the door 22 is closed (YES in step S112), then the processing proceeds to step S113. In step S113, the CPU 151a resets the remaining sheet flags corresponding to all the conveying rollers (sets the remaining sheet flags to off), and the processing returns to step S101. Specifically, the CPU 151a deletes information regarding the remaining sheet stored in the RAM 151c.

Afterward, the CPU 151a repeatedly performs the processing of the flowchart until the remaining sheet flags corresponding to all the conveying rollers as detection targets of the presence of a sheet are set to off.

As described above, in the present exemplary embodiment, if the operation of the image forming apparatus 100 is resumed (e.g., the power supply of the image forming apparatus 100 is turned on), rollers corresponding to the numbers N and N+1 are driven, and the sheet detector 700 detects the presence of a remaining sheet based on the deviation Δθ of a motor for driving the rollers corresponding to the number N. The rollers corresponding to the number N are driven at the peripheral velocity V1, and the rollers corresponding to the number N+1 are driven at the peripheral velocity V2 slower than the peripheral velocity V1 by ΔV. The N-th rollers are thus driven at a peripheral velocity faster than that of the N+1-th rollers, whereby it is possible to make the amount of fluctuation in the load torque applied when a sheet is conveyed by the N-th rollers great. Thus, it is possible to detect a remaining sheet with higher accuracy.

As described above, in the present exemplary embodiment, a sheet remaining in the conveying path is not detected by a sensor, such as a photosensor, but is detected based on a signal output from a motor control device. Consequently, it is possible to determine whether a sheet is nipped by conveying rollers (detect a remaining sheet) without making an apparatus large or increasing cost.

In the present exemplary embodiment, in a case where the absolute value of the deviation Δθ is greater than or equal to the threshold Δθth as determined in step S103 of the flowchart illustrated in FIG. 8, the driving of the N-th and N+1-th conveying rollers is stopped in step S106. The present disclosure, however, is not limited to this flow. For example, a configuration may be employed in which the driving of the N-th conveying rollers is stopped, and the driving of the N+1-th conveying rollers is continued, if the absolute value of the deviation Δθ is greater than or equal to the threshold Δθth.

In the present exemplary embodiment, the driving of the N-th and N+1-th conveying rollers is stopped as executed in step S106 of the flowchart illustrated in FIG. 8, if the state where the absolute value of the deviation Δθ is less than the threshold Δθth continues for the predetermined time TN1. The present disclosure, however, is not limited to this flow. For example, a configuration may be employed in which the driving of the N-th and N+1-th conveying rollers is continued, even if the state where the absolute value of the deviation Δθ is less than the threshold Δθth continues for the predetermined time TN1.

In the present exemplary embodiment, the presence of a remaining sheet is detected based on the deviation Δθ of the motor for driving the downstream rollers (e.g., rollers corresponding to the number N). The present disclosure, however, is not limited to this. For example, the presence or absence of a remaining sheet may be detected based on the deviation Δθ of the motor for driving the upstream rollers (e.g., rollers corresponding to the number N+1). The load torque applied to the motor M1 for driving the conveying rollers 12 decreases, if the front end of a sheet conveyed by the conveying rollers 12 rotating at the peripheral velocity V2 reaches the conveying rollers 13 rotating at the peripheral velocity V1. This is because a force in the rotational direction acts on the conveying rollers 12 due to the fact that the sheet nipped by the conveying rollers 12 is pulled by the conveying rollers 13. Consequently, the absolute value of the deviation Δθ becomes great due to the fact that the rotational phase θ of the rotor of the motor M1 is ahead of the instruction phase θ_ref.

In the present exemplary embodiment, regardless of whether the absolute value of the deviation Δθ is greater than or equal to the threshold Δθth as executed in step S103 of the flowchart in FIG. 8, N is set to N+1 in step S108, if the number N is smaller than n. Specifically, if the conveying rollers 13 and 12 are driven (i.e., N=1), then in step S108, the number N is set so that the conveying rollers 12 and 11 are driven. The present disclosure, however, is not limited to this flow. For example, a configuration may be employed in which N is set to N+2 in step S103, if the absolute value of the deviation Δθ is greater than or equal to the threshold Δθth. Specifically, the number N may be set so that the conveying rollers 11 and the pickup roller 10 are driven, if the absolute value of the deviation Δθ is greater than or equal to the threshold Δθth in the state where the conveying rollers 13 and 12 are driven (i.e., N=1). A configuration may be employed in which N is set to N+3, if n is greater than or equal to 4.

In the present exemplary embodiment, the rollers corresponding to the number N are driven at the peripheral velocity V1, and the rollers corresponding to the number N+1 are driven at the peripheral velocity V2. Then, based on the deviation Δθ of the motor for driving the rollers corresponding to the number N, the presence or absence of a remaining sheet is detected. The present disclosure, however, is not limited to this flow. For example, the pairs of rollers are driven one by one from the rollers corresponding to the number N, if the operation of the image forming apparatus 100 is resumed (e.g., the power supply of the image forming apparatus 100 is turned on). That is, a configuration may be employed in which the sheet detector 700 detects the presence of a sheet based on the deviation Δθ of a motor for driving the downstream conveying rollers, in a state where between adjacent two conveying rollers, the upstream rollers are not driven, and the downstream rollers are driven. The peripheral velocities of the rollers when the presence or absence of a remaining sheet is detected are set to, for example, peripheral velocities slower than the peripheral velocities of the rollers when a sheet is conveyed in the execution of an image forming operation. Specifically, the peripheral velocities of the rollers when the presence of a remaining sheet is detected are set to peripheral velocities, for example, half the peripheral velocities of the rollers when a sheet is conveyed in the execution of an image forming operation.

In the present exemplary embodiment, the conveying rollers 13 are set as the rollers corresponding to N=1. The present disclosure, however, is not limited to this number. For example, the sheet discharge rollers 20 may be set as the rollers corresponding to N=1. In this case, the conveying rollers 11 are set as rollers corresponding to, for example, N=9.

In the present exemplary embodiment, the remaining sheet flag of the N-th rollers is set to on. Alternatively, a configuration may be employed in which the remaining sheet flag of the N+1-th rollers is set to on.

Next, a second exemplary embodiment is described. Components of an image forming apparatus and motor control devices similar to those of the image forming apparatus and the motor control devices according to the first exemplary embodiment are not described.

In the first exemplary embodiment, the driving of the conveying rollers is started again in order from the furthest downstream conveying rollers (corresponding to N=1) after the remaining sheet flags are reset in step S113 as illustrated in FIG. 8, if it is detected that the remaining sheet is present within the image forming apparatus 100. Then, a remaining sheet is detected until the remaining sheet flags corresponding to all the conveying rollers as the detection targets of the presence of a sheet are set to off.

In the second exemplary embodiment, the CPU 151a stores the position of the detected remaining sheet (e.g., the position of conveying rollers of which the remaining sheet flag is set to on), for example, in the RAM 151c, if it is detected that the remaining sheet is present within the image forming apparatus 100. After the remaining sheet flag is reset, the CPU 151a drives the conveying rollers corresponding to the position of the remaining sheet stored in the RAM 151c. Then, the remaining sheet is detected until the remaining sheet flag with respect to the conveying rollers corresponding to the position of the remaining sheet stored in the RAM 151c is set to off. Consequently, it is possible to detect in a shorter time whether a sheet remains within the image forming apparatus 100 after the user clears a jam.

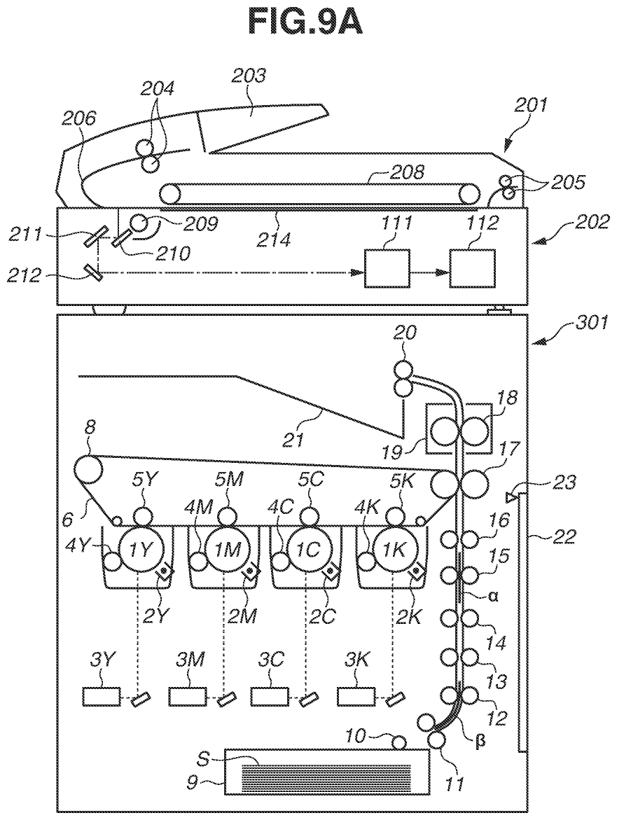

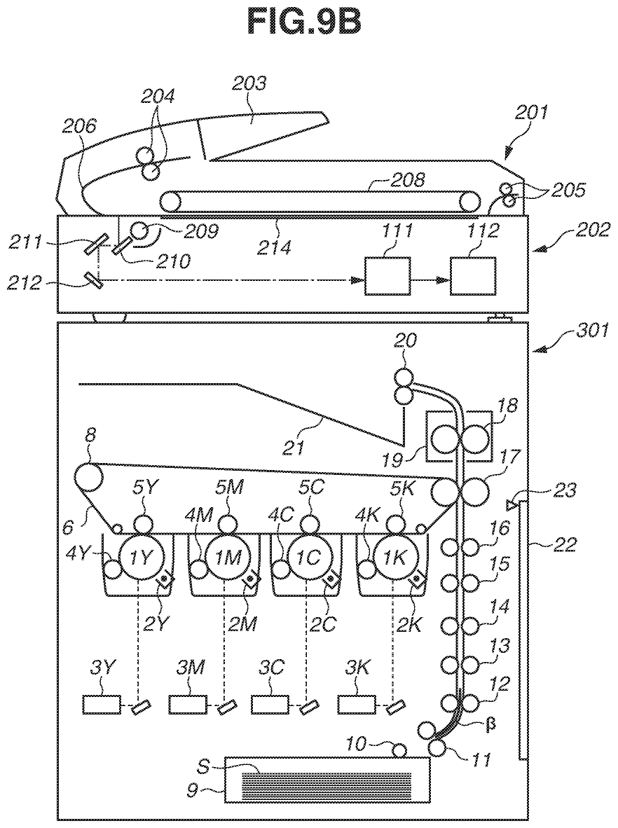

FIGS. 9A and 9B are diagrams illustrating a method for detecting a remaining sheet according to the present exemplary embodiment. FIG. 9A is a diagram illustrating the state where sheets α and β remain within the image forming apparatus 100. FIG. 9B is a diagram illustrating the state of the image forming apparatus 100 in a case where, after the user is notified of the positions where the sheets α and β remain, by displaying the positions on the display unit of the operation unit 152, the user removes the sheet a and does not remove the sheet p.

The CPU 151a notifies the user of information regarding the positions of the sheets α and β by displaying the positions on the display unit included in the operation unit 152, after the CPU 151a sequentially drives the rollers by the method described in the first exemplary embodiment and detects the positions of the sheets α and β. The CPU 151a stores the positions of the sheets α and β (e.g., the positions of conveying rollers of which the remaining sheet flags are on), for example, in the RAM 151c. The CPU 151a sets a number M for the rollers corresponding to the positions stored in the RAM 151c (e.g., the rollers of which the remaining sheet flags are on) in order from the downstream side. In the present exemplary embodiment, the CPU 151a sets, for example, M=1 for the conveying rollers 15 corresponding to the position of the sheet a, and sets M=2 for the conveying rollers 12 corresponding to the position of the sheet 3.

When it is detected that the door 22 is closed, the CPU 151a drives the rollers corresponding to the number M=1 (e.g., the conveying rollers 15 in the present exemplary embodiment) at the peripheral velocity V2, and drives rollers downstream of the rollers corresponding to the number M=1 (e.g., the registration rollers 16 in the present exemplary embodiment) at the peripheral velocity V1. Afterward, the CPU 151a drives the rollers corresponding to the number M=2 (e.g., the conveying rollers 12 in the present exemplary embodiment) at the peripheral velocity V2, and drives rollers (e.g., the conveying rollers 13 in the present exemplary embodiment) downstream of the rollers corresponding to the number M=2 at the peripheral velocity V1.

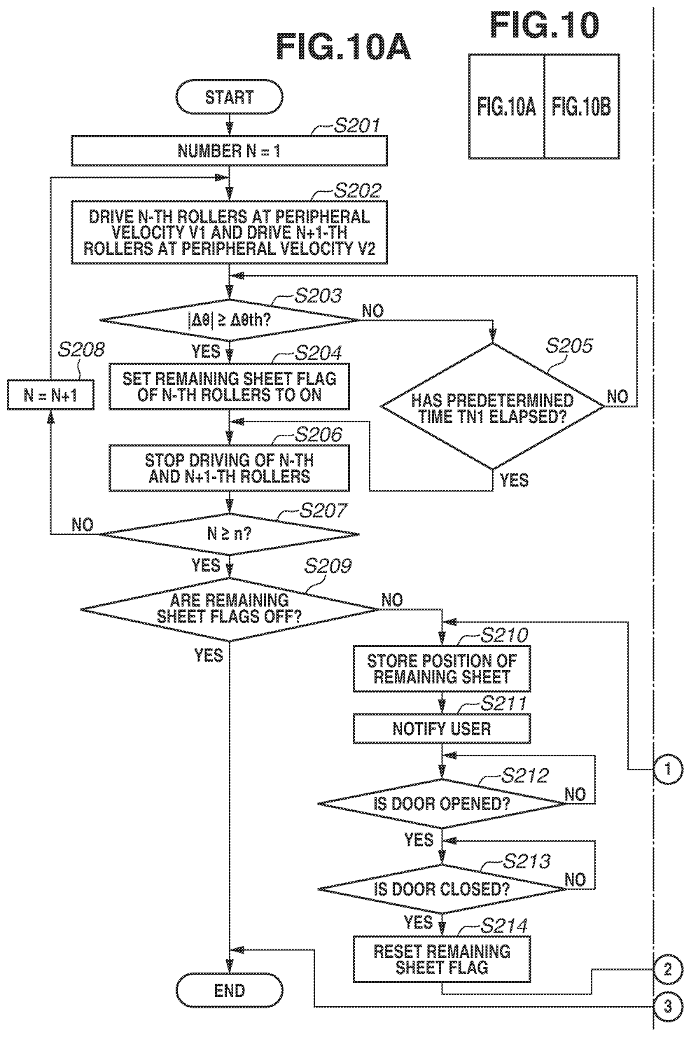

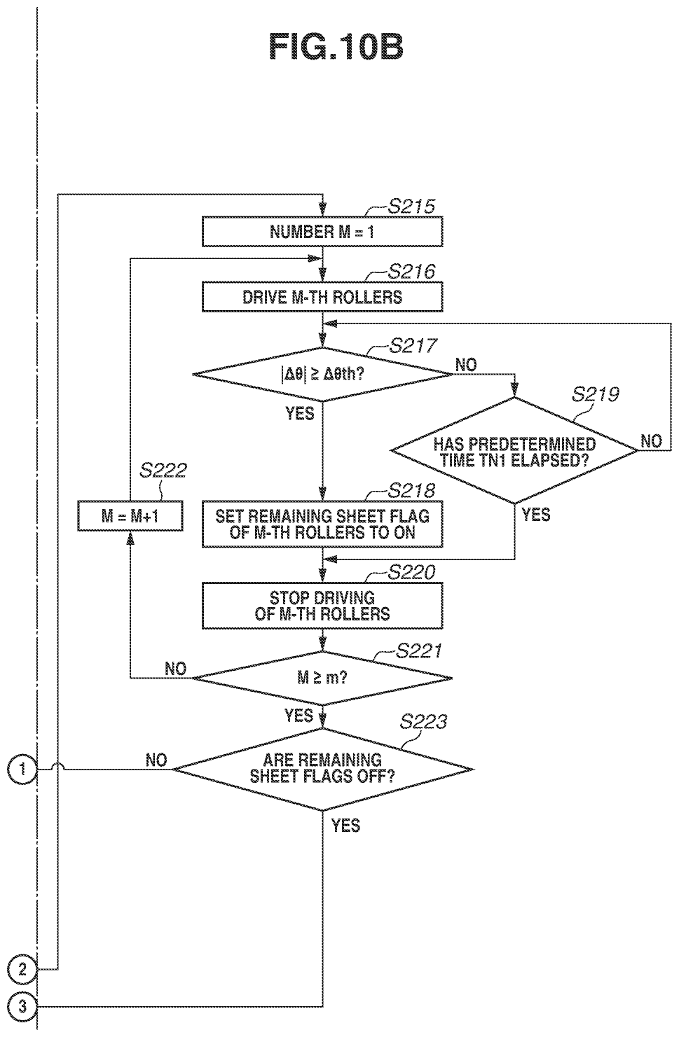

FIG. 10 (consisting of FIGS. 10A and 10B) is a flowchart illustrating the method for detecting a sheet remaining in the conveying path. With reference to FIG. 10, a description is given below of the method for detecting a sheet remaining in the conveying path. The processing of the flowchart is executed by the CPU 151a. The processing of the flowchart is started when the power supply of the image forming apparatus 100 enters an on state, i.e., in the state where an image forming process has not yet started.

The processes of steps S201 to S209 are similar to the processes of steps S101 to S109 illustrated in FIG. 8, and therefore are not described here.

In step S210, the CPU 151a stores the position of the detected remaining sheet (e.g., the position of the rollers of which the remaining sheet flag is set to on), for example, in the RAM 151c. The CPU 151a sets the number M for the rollers corresponding to the position stored in the RAM 151c (i.e., the rollers of which the remaining sheet flag is on) in order from the downstream side.

The processes of steps S211 to S213 are similar to the processes of steps S110 to S112 illustrated in FIG. 8, and therefore are not described here.

In step S214, the CPU 151a resets the remaining sheet flag, and the processing proceeds to step S215.

In step S215, the CPU 151ₐ sets the number M to ‘1’.

In step S216, the CPU 151ₐ rotates the rollers corresponding to the number M at the peripheral velocity V2. The CPU 151a rotates rollers downstream of the rollers corresponding to the number M at the peripheral velocity V1.

In step S217, if the sheet detector 700 outputs a signal indicating that the absolute value of the deviation Δθ of a motor for driving the rollers downstream of the rollers corresponding to the number M driven in step S216 is greater than or equal to the threshold Δθth (YES in step S217), the processing proceeds to step S218. In step S218, the CPU 151a sets the remaining sheet flag of the rollers corresponding to the number M to on. Specifically, the CPU 151a stores, for example, in the RAM 151c, information indicating that a sheet is nipped by the rollers corresponding to the number M.

In step S217, if the absolute value of the deviation Δθ of the motor for driving the rollers downstream of the rollers corresponding to the number M driven in step S216 is less than the threshold Δθth (NO in step S217), the processing proceeds to step S219.

In step S219, if the predetermined time TN1 has not elapsed since the motor has been driven in step S216 (NO in step S219), the processing returns to step S217.

In step S219, if the predetermined time TN1 has elapsed since the motor has been driven in step S216 (YES in step S219), the processing proceeds to step S220. In step S220, the CPU 151a outputs, to motor control devices that control motors for driving the respective pairs of rollers, instructions to stop the driving of the pairs of rollers. Consequently, the driving of the pairs of rollers is stopped.

In step S221, if the number M is less than m (NO in step S221), the processing proceeds to step S222. In step S222, the CPU 151a sets M=M+1, and the processing returns to step S216. In the above description, m represents the number of pieces of information regarding the position of the remaining sheet stored in the RAM 151c in step S210.

In step S221, if the number M is greater than or equal to m (YES in step S221), the processing proceeds to step S223.

In step S223, if there are rollers of which the remaining sheet flag is on (YES in step S223), the processing returns to step S210.

Afterward, the CPU 151a repeatedly performs the processing of the flowchart until the remaining sheet flags corresponding to all the conveying rollers as detection targets of the presence of a sheet are set to off.

As described above, in the present exemplary embodiment, the CPU 151a stores the position of the detected remaining sheet (e.g., the position of conveying rollers of which the remaining sheet flag is set to on), for example, in the RAM 151c, if it is detected that the remaining sheet is present within the image forming apparatus 100. After the remaining sheet flag is reset, the CPU 151a drives the rollers corresponding to the position of the remaining sheet stored in the RAM 151c. Consequently, it is possible to detect in a shorter time whether a sheet remains within the image forming apparatus 100 after the user clears a jam.

In the present exemplary embodiment, the presence of a remaining sheet is detected based on the deviation Δθ of the motor for driving the rollers downstream of the rollers corresponding to the number M. The present disclosure, however, is not limited to this flow. For example, the presence of a remaining sheet may be detected based on the deviation Δθ of the motor for driving the rollers corresponding to the number M.

In the present exemplary embodiment, both the rollers corresponding to the number M and the rollers downstream of the rollers corresponding to the number M are driven. The present disclosure, however, is not limited to this control. For example, the rollers corresponding to the number M may be driven, and the presence of a remaining sheet may be detected based on the deviation Δθ of the motor for driving the rollers.

In the present exemplary embodiment, the remaining sheet flag of the M-th rollers is set to on. Alternatively, a configuration may be employed in which the remaining sheet flag of the M+1-th rollers is set to on.

In the first and second exemplary embodiments, the time in which the motors are driven is a predetermined time, when a sequence for detecting a remaining sheet is executed. The present disclosure, however, is not limited to this control. For example, the driving time may be changed for each pair of rollers or each motor as a driving target.

In the first and second exemplary embodiments, the downstream rollers and the upstream rollers are driven in the state where the peripheral velocity of the downstream rollers is faster by ΔV than that of the upstream rollers. The present disclosure, however, is not limited to this control. For example, the downstream rollers and the upstream rollers may be driven in the state where the peripheral velocity of the downstream rollers is slower by ΔV than that of the upstream rollers.

In the first and second exemplary embodiments, the threshold for the deviation Δθ is a predetermined value, regardless of the paper type. Alternatively, the threshold may be set with respect to each paper type.

In the first and second exemplary embodiments, the difference in peripheral velocity ΔV is set to a predetermined value, regardless of the type of the sheet that is conveyed (i.e., the paper type). The present disclosure, however, is not limited to this control. For example, the difference in peripheral velocity ΔV may be set according to the paper type set by the user. Further, a difference in peripheral velocity ΔV corresponding to thick paper may be smaller than a difference in peripheral velocity ΔV corresponding to thin paper or a difference in peripheral velocity ΔV corresponding to plain paper. The difference in peripheral velocity ΔV corresponding to plain paper may be smaller than the difference in peripheral velocity ΔV corresponding to thin paper.

In the first and second exemplary embodiments, the detection of a remaining sheet is started, when the power supply of the image forming apparatus 100 enters an on state. The present disclosure, however, is not limited to this control. For example, the detection of a remaining sheet may be started when the image forming apparatus 100 returns from a sleep state after the clearance of a jam in the image forming apparatus 100 is completed. That is, it is only necessary to employ a configuration in which the detection of a remaining sheet is started during the period from when the conveyance of a sheet is stopped to when the operation of feeding a sheet is resumed. The sleep state corresponds to a power saving mode for reducing power to be consumed by the image forming apparatus 100, for example, in a case where the operation of the image forming apparatus 100 is not performed for a predetermined period.

In the first and second exemplary embodiments, a single motor is provided for each pair of rollers. Alternatively, a configuration may be employed in which a single motor drives two pairs of rollers. For example, the motor M1 may drive the conveying rollers 13 and 12. In such a configuration, for example, the rotating shaft of the motor M1 is connected to each pair of rollers via a clutch. By connecting and separating the motor M1 and each pair of rollers using the clutch, the motor M1 can drive one or two pairs of rollers.

In the first and second exemplary embodiments, the sheet detector 700 outputs a signal indicating that the absolute value of the deviation is greater than or equal to the threshold in a case where the absolute value of the deviation is greater than or equal to the threshold, and the sheet detector 700 outputs a signal indicating that the absolute value of the deviation is less than the threshold in a case where the absolute value of the deviation is less than the threshold. The present disclosure, however, is not limited to this control. For example, a configuration may be employed in which the sheet detector 700 outputs to the CPU 151a a signal indicating that a sheet is nipped by conveying rollers, if the absolute value of the deviation changes from a value smaller than the threshold to a value greater than or equal to the threshold.

In the first and second exemplary embodiments, a remaining sheet is detected based on the deviation Δθ. The present disclosure, however, is not limited to this control. Alternatively, for example, a remaining sheet may be detected based on a current value iq output from the coordinate transformer 511. Yet alternatively, a remaining sheet may be detected based on a change in the q-axis current instruction value (target value) iq_ref determined based on the deviation between the instruction phase θ_ref and the rotational phase θ determined by the phase determiner 513. Yet alternatively, a remaining sheet may be detected based on a change in the amplitude (magnitude) of the current value iα or iβ in the stationary coordinate system.

The CPU 151a may have the function of the sheet detector 700.

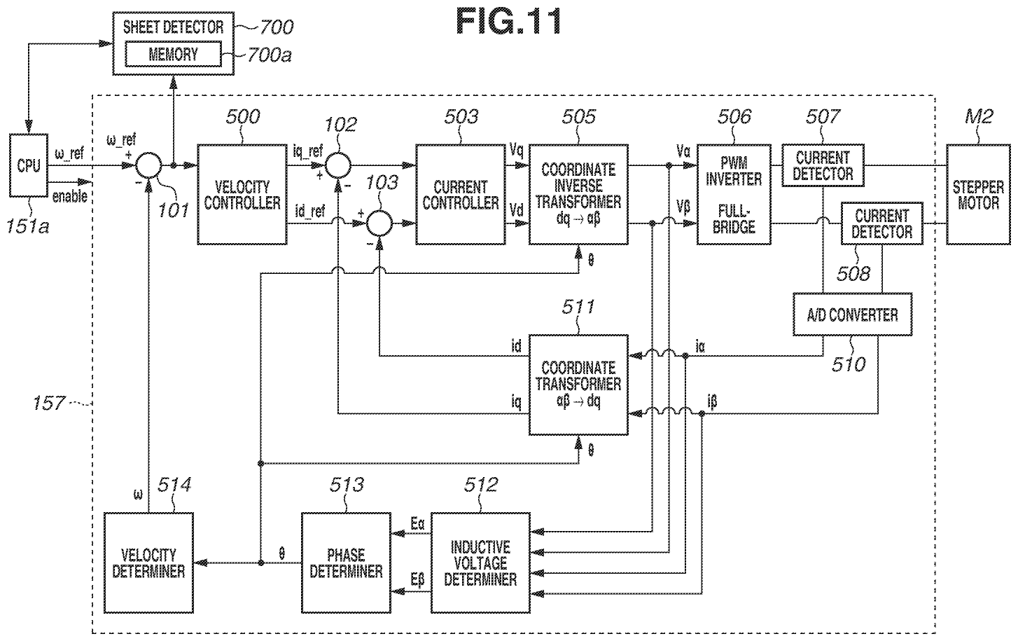

In the vector control according to the first and second exemplary embodiments, the motor M2 is controlled by performing phase feedback control. The present disclosure, however, is not limited to this configuration. For example, a configuration may be employed in which the motor M2 is controlled by feeding back a rotational velocity ω of the rotor 402. Specifically, as illustrated in FIG. 11, a velocity determiner 514 included in the motor control device 157 determines the rotational velocity ω based on the amount of change in the rotational phase θ during a predetermined period output from the phase determiner 513. The rotational velocity ω is determined using the following formula (10).

ω=dθ/dt (10)

The CPU 151a outputs an instruction velocity ω_ref that indicates a target velocity of the rotor 402. Further, a configuration is employed in which a velocity controller 500 is provided within the motor control device 157. The velocity controller 500 generates the q-axis current instruction value iq_ref and the d-axis current instruction value id_ref so that the deviation between the rotational velocity ω and the instruction velocity ω_ref becomes small. A configuration may be employed in which the motor M2 is controlled by performing such velocity feedback control. In such a configuration, a remaining sheet is detected by the methods described in the present exemplary embodiments, for example, based on a deviation Δω between the rotational velocity ω and the instruction velocity ω_ref. The instruction velocity ω_ref is a target velocity of the rotor 402 of the motor M2 corresponding to a target velocity of the peripheral velocity of the rollers 13.

An application of the first and second exemplary embodiments is not limited to motor control by vector control. For example, the first and second exemplary embodiments can be applied to any motor control device having a configuration for feeding back a rotational phase or a rotational velocity.

In the first and second exemplary embodiments, a stepper motor is used as a motor for driving a load. Alternatively, another motor, such as a direct current (DC) motor, may be used. The motor is not limited to a two-phase motor, and the first and second exemplary embodiments can also be applied to another motor such as a three-phase motor.

The deviations Δθ and Δω, the current value iq, the current value iq_ref, and the amplitude of the current value iα or iβ in the stationary coordinate system correspond to parameters corresponding to the load torque applied to the rotor of the motor. Changes of the parameters corresponding to the load torque occur when a sheet is conveyed by adjacent pairs of conveying rollers (e.g., the conveying rollers 13 and 12).

In the first and second exemplary embodiments, a permanent magnet is used as the rotor 402. The present disclosure, however, is not limited to configuration.

According to the present disclosure, it is possible to detect a sheet with high accuracy using a less expensive configuration.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-033292, filed Feb. 26, 2019, which is hereby incorporated by reference herein in its entirety.

What is claimed is:

1. A sheet conveying apparatus that conveys a sheet, the sheet conveying apparatus comprising:
a stacking unit in which the sheet is stacked;
a feeding unit configured to feed the sheet stacked in the stacking unit;
a conveying path in which the sheet is conveyed;
a first conveying roller provided downstream of the feeding unit in a conveying direction in which the sheet is conveyed, the first conveying roller configured to convey the sheet fed by the feeding unit;
a second conveying roller provided downstream of the feeding unit in a conveying direction, the second conveying roller configured to be fed by the feeding unit;
a controller configured to, after an on timing when a power supply of the sheet conveying apparatus switches from an off state to an on state, and before a feeding timing when the feeding unit starts feeding the sheet first after the on timing, execute first driving for executing a driving of the first conveying roller and a driving of the second conveying roller;
a discriminator configured to determine a position of the sheet in the conveying path based on a value of a parameter corresponding to a load torque applied to a motor for driving a conveying roller driven during the first driving; and
a storage unit configured to store information regarding the position determined by the discriminator,
wherein, after the first driving is completed, the controller executes second driving for driving a conveying roller corresponding to the position, and
wherein the discriminator determines the position of the sheet in the conveying path based on the value of the parameter corresponding to the load torque applied to a motor for driving a conveying roller driven during the second driving.

2. The sheet conveying apparatus according to claim 1, further comprising:
a phase determiner configured to determine a rotational phase of a rotor of a motor for driving the first conveying roller,
wherein the controller controls a driving current flowing through a coil of the motor for driving the first conveying roller so that a deviation between an instruction phase indicating a target phase of the rotor and the rotational phase determined by the phase determiner becomes small.

3. The sheet conveying apparatus according to claim 2, wherein the controller controls the driving current based on a value of a torque current component represented in a rotating coordinate system based on the rotational phase of the rotor.

4. The sheet conveying apparatus according to claim 2,
wherein the parameter corresponding to the load torque is the deviation, and
wherein in a case where an absolute value of the deviation is greater than a predetermined value, the discriminator determines that the sheet is present in a nip portion of the first conveying roller.

5. The sheet conveying apparatus according to claim 4, wherein in a case where a state where the absolute value of the deviation is smaller than the predetermined value continues for a predetermined time, the discriminator determines that the sheet is not present in the nip portion of the first conveying roller that is being driven.

6. The sheet conveying apparatus according to claim 1, further comprising:
a velocity determiner configured to determine a rotational city of a rotor of a motor for driving the first conveying roller,
wherein the controller controls a driving current flowing through a coil of the motor for driving the first conveying roller so that a deviation between an instruction velocity indicating a target velocity of the rotor and the rotational velocity determined by the velocity determiner becomes small.

7. The sheet conveying apparatus according to claim 6, wherein the controller controls the driving current based on a value of a torque current component represented in a rotating coordinate system based on the rotational phase of the rotor.

8. The sheet conveying apparatus according to claim 7,
wherein the parameter corresponding to the load torque is the deviation, and
wherein in a case where an absolute value of the deviation is greater than a predetermined value, the discriminator determines that the sheet is present in a nip portion of the first conveying roller.

9. The sheet conveying apparatus according to claim 8, wherein in a case where a state where the absolute value of the deviation is smaller than the predetermined value continues for a predetermined time, the discriminator determines that the sheet is not present in the nip portion of the first conveying roller that is being driven.

10. The sheet conveying apparatus according to claim 1, further comprising:
a notification unit configured to notify a user of the information stored in the storage unit.
